(19) United States
(12) Patent Application Publication
(10) Pub. No.: US 2012/0204044 A1
(43) Pub. Date: Aug. 9, 2012

(54) METHOD OF CONTROLLING NETWORK SYSTEM

(76) Inventors: Sangsu Lee, Seoul (KR); Baejin Lee, Seoul (KR); Changkwon Park, Seoul (KR); Munseok Seo, Seoul (KR); Daegeun Seo, Seoul (KR); Dalho Cheong, Seoul (KR); Junho Ahn, Seoul (KR); Hoonbong Lee, Seoul (KR); Bongmun Jang, Seoul (KR)

(21) Appl. No.: 13/501,993

(22) PCT Filed: Oct. 20, 2010
(86) PCT No.: PCT/KR10/07180

§ 371 Date: Apr. 13, 2012

(30) Foreign Application Priority Data
Oct. 20, 2009 (KR) 10-2009-0099724
Jul. 9, 2010 (KR) 10-2010-0066216

(51) Int. Cl. G06F 1/32

(52) U.S. Cl. 713/320

(57) ABSTRACT

Provided is a method of controlling a network system. The method includes recognizing power information and an operation mode of an electric product, and providing an energy-saving operation mode to the electric product or operating the electric product in the energy-saving operation mode for reducing an energy-related value based on the recognized power information and the operation mode of the electric product.

### TECHNICAL FIELD

The present disclosure relates to a method of controlling a network system.

### BACKGROUND ART

Electric products operate while consuming electric energy. Since electric products consume electric energy, the amount of electricity consumption or electricity charge may be a sensitive matter to users.

As energy consumption increases, it is necessary to develop more energy sources and produce more electric energy. However, electricity generation causes a large amount of greenhouse gas and environmental problems such as global warming. To reduce emission of greenhouse gas, particularly, carbon dioxide, alternative energy sources have been developed such as wind power, solar light, solar heat, geothermal power, tidal power, and water power as well as nuclear power and fuel cells.

Along with this, a smart grid has been proposed as the next generation power grid to improve energy efficiency by realizing two-way and real-time information exchange between power providers and consumers in a way of applying information technology (IT) to the existing power grid.

### DISCLOSURE OF INVENTION

### Technical Problem

Embodiments provide a method of controlling a network system to operate electric products according to power information and manage electricity efficiently.

### Solution to Problem

In one embodiment, there is provided a method of controlling a network system, the method including: recognizing power information and an operation mode of an electric product; and providing an energy-saving operation mode to the electric product or operating the electric product in the energy-saving operation mode for reducing an energy-related value based on the recognized power information and the operation mode of the electric product.

The details of one or more embodiments are set forth in the accompanying drawings and the description below. Other features will be apparent from the description and drawings, and from the claims.

### Advantageous Effects of Invention

According to the embodiments, when a user inputs or selects an operation mode of an electric product, a power-saving operation mode, which is advantageous in reducing power consumption or electricity charge as compared with the input operation mode, is recommended to reduce power consumption or electricity charge.

In addition, since a saved electricity charge, a reduced power consumption amount, or a reduced carbon dioxide emission amount is displayed after the electric product is operated in the recommended power-saving operation mode, a user can check the information, and thus the user may be encouraged to use the power-saving operation mode.

### BRIEF DESCRIPTION OF DRAWINGS

FIG. 1 is a schematic view illustrating a network system of an embodiment.

FIG. 2 is a view illustrating a power line communication network in a residential customer.

FIG. 3 is a view illustrating an energy management system (EMS) according to an embodiment.

FIG. 4 is a control block diagram illustrating a network system according to an embodiment.

FIG. 5 is a control block diagram illustrating a network system according to another embodiment.

FIGS. 6 and 7 are flowcharts for explaining a method of controlling a network system according to a first embodiment.

FIG. 8 is a flowchart for explaining a method of controlling a network system according to a second embodiment.

FIG. 9 is a view illustrating a screen of an electric product or an EMS on which different information is displayed according to the network system controlling method of FIG. 8.

FIG. 10 is a graph illustrating a change of an operation time period of an electric product according to a desired electricity charge.

FIG. 11 is a graph illustrating an on-peak time period and an off-peak time period.

### MODE FOR THE INVENTION

Reference will now be made in detail to the embodiments of the present disclosure, examples of which are illustrated in the accompanying drawings.

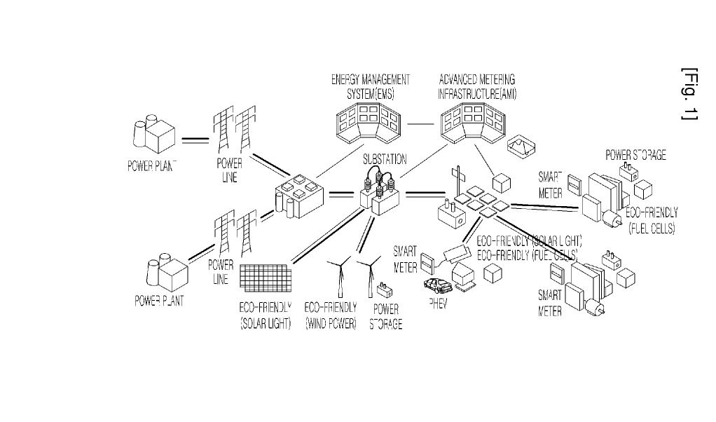

FIG. 1 is a schematic view illustrating a network system of an embodiment.

Referring to FIG. 1, the network system of the current embodiment includes a power plant generating electricity by thermal power generation, nuclear power generation, or water power generation; and a solar power plant and a wind power plant that generate electricity from renewable energy sources such as solar light and wind power.

The power plant, such as a thermal power plant, a nuclear power plant, and a water power plant, supplies electricity to a sub-control center through a power line, and the sub-control center supplies the electricity to a substation where the electricity is distributed to consumers such as residential customers or offices.

Electricity generated from renewable energy sources is delivered to the substation where the electricity is distributed to consumers. Electricity transmitted from the substation is distributed to consumers such as offices and residential customers through power storages.

Residential customers using a home area network (HAN) may produce electricity by using a solar battery or fuel cells of a plug in hybrid electric vehicle (PHEV) for their own use or selling the remaining electricity.

In addition, since smart metering devices are provided to consumers such as offices or residential customers, power consumption or electricity bills can be checked in real time, and thus the consumers can take action to reduce power consumption or electricity costs based on the real-time information about power consumption and electricity bills.

Furthermore, since the power plants, the sub-control center, the power storages, and the consumers can communicate with each other (two-way communication), electricity is not transmitted to the consumers unilaterally but generated and distributed to the consumers according to the consumers' situations notified to the power storages, the sub-control center, and the power plants.

In such a smart grid, an energy management system (EMS) plays a pivotal role for real-time power line communication with a consumer, and an advanced metering infrastructure (AMI) plays a pivotal role for real-time power consumption measurement.

The AMI of the smart grid is backbone technology for integrating consumers based on an open architecture. The AMI provides consumers with the ability to use electricity efficiently and power providers with the ability to detect problems on their systems and operate them efficiently.

Herein, the open architecture means a standard for connecting all electric products in a smart grid system regardless of the manufactures of the electric products, unlike in a general communication network.

Therefore, the AMI of the smart grid enables consumer-friendly efficiency concepts like “prices to devices.”

That is, real-time price information of an electricity market may be displayed on an EMS and a smart meter of each residential customer, and the EMS and the smart meter may control electric products while communicating with the electric products. Thus, a user may see the information displayed on the EMS or the smart meter to check power information of each electric product and carry out power information processing such as power consumption limit setting or electricity charge limit setting to save energy and reduce costs.

In addition, a smart control device is provided in each electric product to collect operational state information of the electric product and receive power information and environment information such as temperature and humidity from the EMS or the smart meter to control the operation of the electric product.

Each electric product may be controlled based on communication among the smart control device, the EMS, and the smart meter.

The EMS may include local EMSs provided in offices or residential customers, and a central EMS configured to process information collected from the local EMSs through two-way communication.

Since real-time communication is possible between providers and consumers in a smart grid for exchanging power information, real-time grid response can be realized, and costs necessary for meeting a peak demand can be reduced.

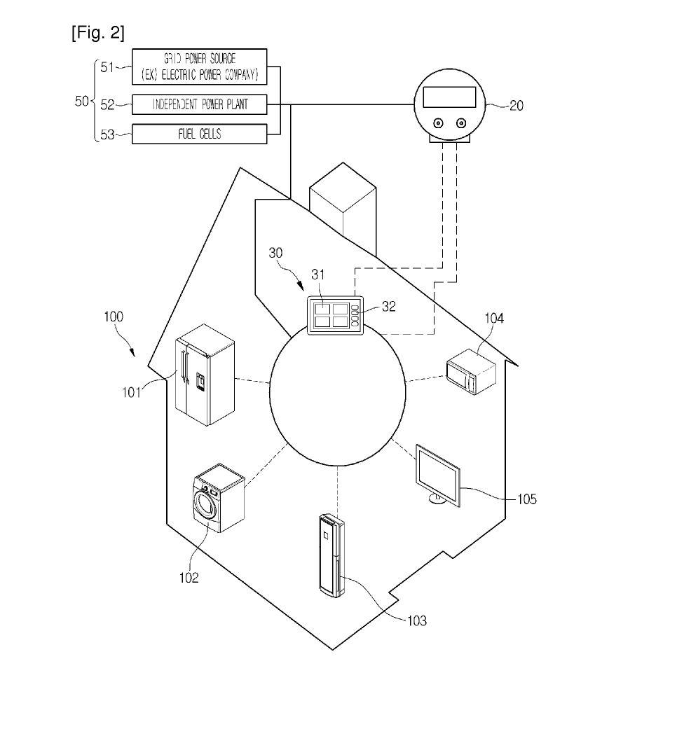

FIG. 2 is a view illustrating a power line communication network 10 in a residential customer.

Referring to FIG. 2, the power line communication network 10 includes: a smart meter 20, which can receive power information such as information about power supplied to the residential customer and the electricity rate of the power and measure power consumption and electricity charge in real time; and an EMS 30 connected to the smart meter 20 and capable of communicating with one or more electric products 100 and controlling the electric products 100.

The smart meter 20, the EMS 30, and the electric products 100 of the power line communication network 10 may be collectively referred to as “communication components.”

That is, in the power line communication network 10, one component can communicate with another component for exchanging information and control the other component according to the information.

The EMS 30 may be provided in the form of a terminal, which includes a screen 31 to display the current power consumption state and external environments (temperature, humidity) and an input unit 32 to receive user's manipulations.

The EMS 30 is connected to the electric products 100 such as a refrigerator 101, a washing or drying machine 102, an air conditioner 103, a TV 105, and a cooking device 104 through an in-house network for two-way communication.

In-house communication may be performed by wireless or power line communication (PLC). Furthermore, the electric products 100 may be connected to each other for communicating with each other.

A power supply source 50 that supplies power to the residential customer may be a grid power source 51 including general power plant equipment (e.g., a thermal power plant, a nuclear power plant, and a wind power plant) or power plant equipment using renewable energy sources (e.g., solar light, wind power, and geothermal power). For example, the power supply source 50 may be provided by an electric power company.

The power supply source 50 may further include an independent power plant 52 such as a solar power plant of the residential customer, and fuel cells 53 of a vehicle or the residential customer.

Generally, the power supply source 50 is connected to the smart meter 20 and the EMS 30 to provide power information to the smart meter 20 and the EMS 30, and the information is used to control the electric products 100.

Alternatively, information may be provided from the power supply source 50 directly to communication devices (not shown) of the electric products 100, or the grid power source 51 (electric power company) may provide information to control a particular electric product of the residential customer.

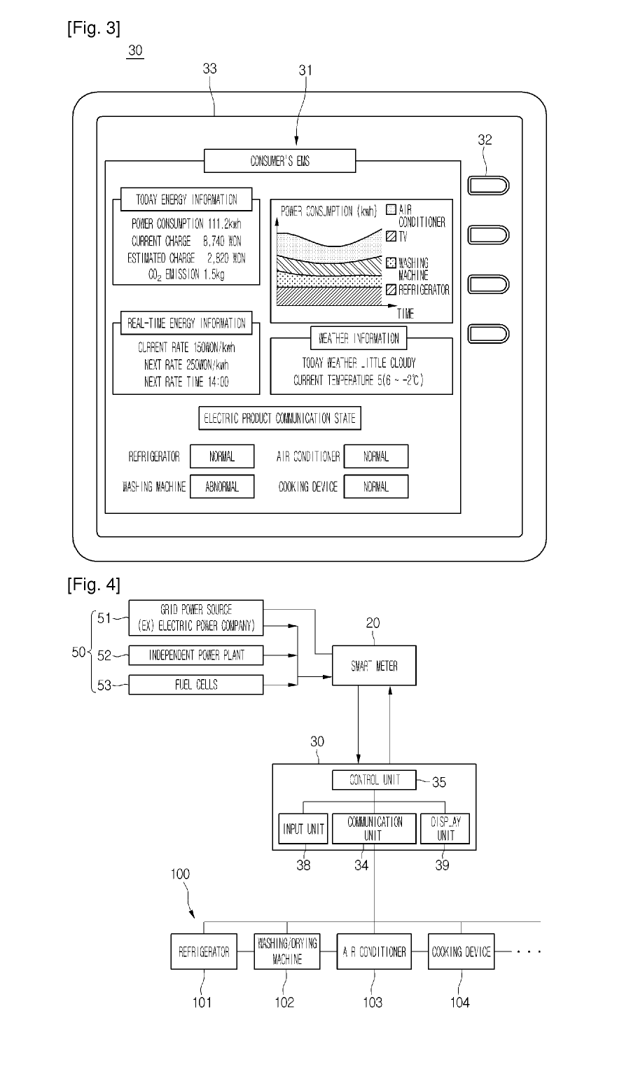

FIG. 3 is a view illustrating an energy management system (EMS) 30 according to an embodiment.

Referring to FIG. 3, the EMS 30 may be a terminal including a touch panel 33.

A screen 31 may be displayed on the touch panel 33 to provide information about an electricity consumption amount, a current electricity charge, an electricity charge estimated based on an accumulated consumption history, a carbon dioxide emission amount, an electricity rate of a current time period, and an electricity rate of a next time period; real-time energy information including information about a time period the electricity rate of which varies with time; and weather information.

In addition, a graph may be displayed on the screen 31 of the touch panel 33 to show power consumption amounts of electric products with respect to time. In addition, on/off states may be displayed to give information about whether power is supplied to the electric products. In addition, energy information may be displayed on the screen 31 for the respective electric products. For example, energy information according to a user's setting and energy information according to a power-saving operation mode recommended by the EMS 30 may be displayed for comparing them.

For example, energy information such as estimated operation time, power consumption, electricity charge, and carbon dioxide emission may be displayed. However, energy information is not limited to the listed items.

An input unit 32 is provided at a side of the screen 31 so that a user can input settings to the electric products using the input unit 32. A user can set a power consumption limit or an electricity charge limit by using the input unit 32, and the EMS 30 may control the electric products according to the user's setting.

FIG. 4 is a control block diagram illustrating a network system according to an embodiment.

Referring to FIG. 4, a power supply source 50 may include a grid power source 51, an independent power plant 52, or fuel cells 53. The power supply source 50 may be connected to a smart meter 20 or an EMS 30.

The EMS 30 may include a control unit 35, an input unit 38, a communication unit 34, and a display unit 39.

The communication unit 34 communicates with in-house electric products 100 such as a refrigerator 101, a washing or drying machine 102, an air conditioner 103, and a cooking device 104 for transmitting and receiving power information and operation information.

The control unit 35 checks setting information input by a user through the input unit 38, accumulated history information about operations and power consumptions of the electric products 100, and real-time information about the supply amount of electricity. Then, the control unit 35 processes the information in real time to control operations of the electric products 100 and power to the electric products 100.

The EMS 30 shown in FIG. 4 may be a wireless or wire terminal separate from the electric products 100.

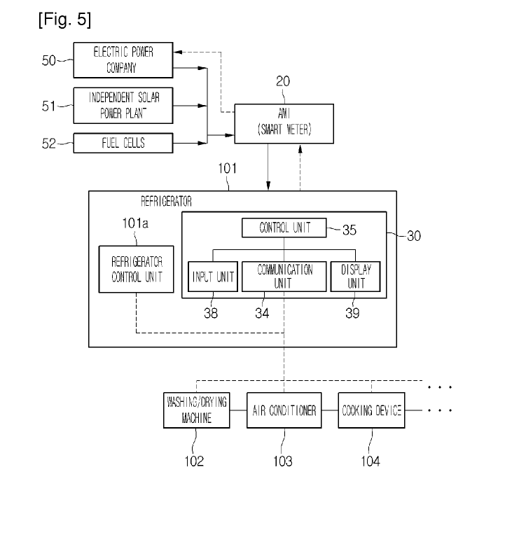

FIG. 5 is a control block diagram illustrating a network system according to another embodiment.

Referring to FIG. 5, an EMS 30 may be provided in a refrigerator 101 that operates all day long.

Separately from a control unit 101a of the refrigerator 101, the EMS 30 may include a control unit 35, a communication unit 34, an input unit 38, and a display unit 39 to transmit, receive, and process operational signals and power information of all electric products.

Except for the position of the EMS 30, operations of the EMS 30 are equal to those of the EMS 30 shown in FIG. 4, and thus descriptions thereof will not be repeated.

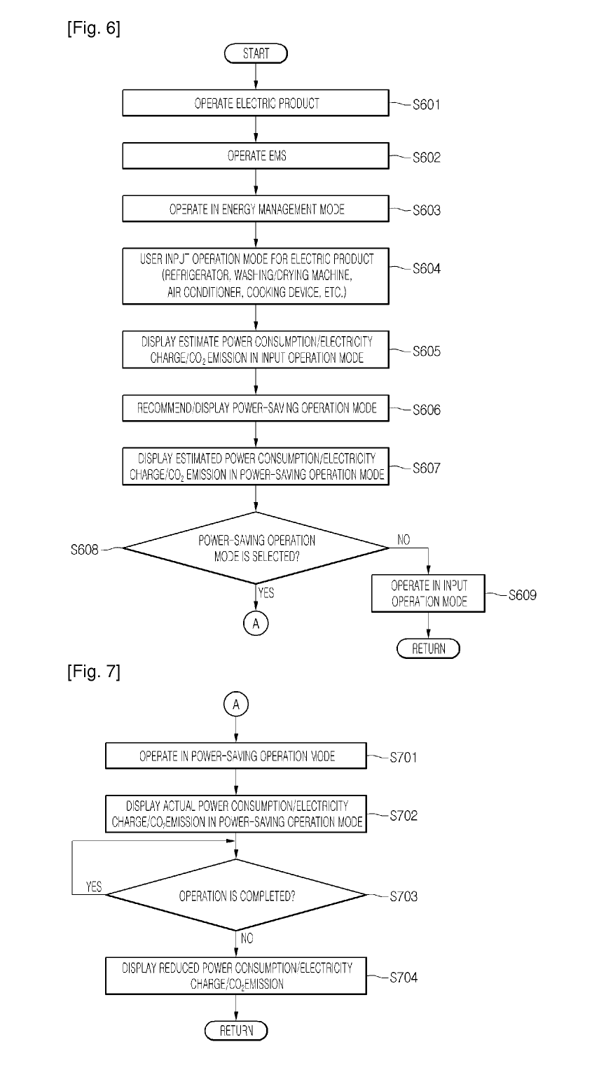

FIGS. 6 and 7 are flowcharts for explaining a method of controlling a network system according to a first embodiment.

Referring to FIGS. 6 and 7, if a user operates an electric product (S601) and an EMS (S602), an energy management mode (electricity charge or power consumption reducing mode) is started to reduce electricity charge and/or power consumption (these may be referred to as energy-related values) (S603).

Next, the user inputs an operation mode for a particular electric product (S604). For example, the operation mode may involve an indoor temperature and an intense operation for the case of an air conditioner, a laundry course (standard or soaking) for the case of a washing machine, a cooking course for the case of a cooking device, and an intense freezing operation for the case of a refrigerator.

Then, an estimated power consumption amount, an estimated electricity charge, or an estimated carbon dioxide emission amount is displayed on the EMS (S605). Such information may also be displayed on a display unit of the electric product.

Thereafter, the EMS recommends a power-saving operation mode corresponding to the input operation mode by displaying the power-saving operation mode (S606). In the current embodiment, the power-saving operation mode means an operation mode suitable for reducing energy-related values of the electric product.

For example, in the case where the electric product is an air conditioner, if a set indoor temperature is too low as compared with indoor and outdoor temperatures, a power-saving operation mode may be recommended to increase the set indoor temperature and the air rate of a fan.

In the case where the electric product is a washing machine and it is determined that the current set washing course is not suitable because the supply amount of water and washing time are excessive as compared with the weight of laundry and so on, another washing course may be selected to reduce the supply amount of water and washing time.

After recommending the power-shaving mode, the EMS displays an estimated power consumption amount, an estimated electricity charge, or an estimated carbon dioxide emission amount in case where the electric product is operated in the power-saving operation mode (S607).

It is determined whether the user selects the recommended power-saving operation mode (S608). If it is determined that the power-saving operation mode is not selected, the operation mode input by the user is performed (S609).

If it is determined that the user selects the power-saving operation mode, the power-saving operation mode is performed (S701), and the EMS displays an actual power consumption amount, an actual electricity charge, or an actual carbon dioxide emission amount in the power-saving operation mode (S702).

Thereafter, it is determined whether the operation of the electric product is completed (S703). If it is determined that the operation of the electric product is completed, the EMS displays information (which was not displayed when the electric product was being displayed in the power-saving operation mode) such as a saved electricity charge, a reduced power consumption amount, or a reduced carbon dioxide emission amount during the power-saving operation mode (S704).

In the above embodiment, a user can select a recommended power-saving operation mode. However, an electric product may be automatically operated in power-saving operation mode, and this information may be displayed to inform a user.

According to the present disclose, when a user inputs or selects an operation mode of an electric product, a power-saving operation mode, which is advantageous in reducing power consumption or electricity charge (energy-related values) as compared with the input operation mode, is recommended to reduce power consumption or electricity charge.

In addition, since a saved electricity charge, a reduced power consumption amount, or a reduced carbon dioxide emission amount is displayed after the electric product is operated in the recommended power-saving operation mode, a user can check the information, and thus the user may be encouraged to use the power-saving operation mode.

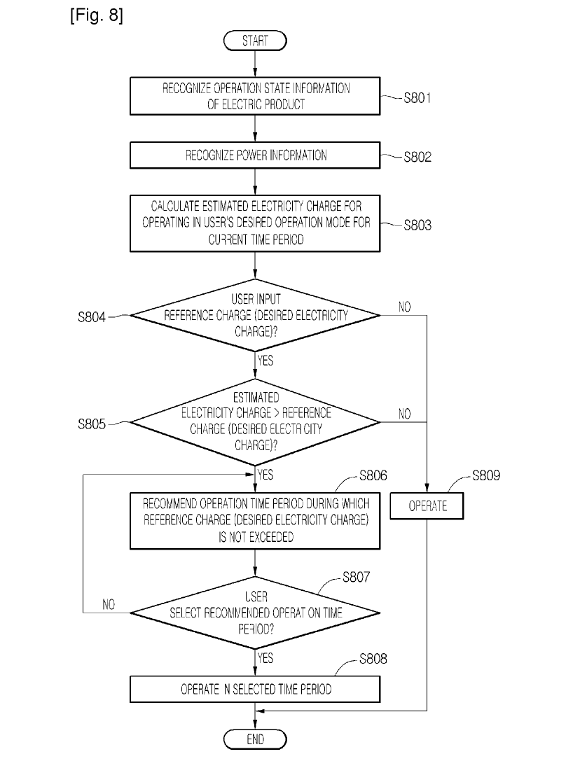

FIG. 8 is a flowchart for explaining a method of controlling a network system according to a second embodiment.

In the current embodiment, control units included in communication components such as the EMS 30, the smart meter 20, and an electric product will be collectively referred to as a control device.

Referring to FIG. 8, the control device recognizes operation state information of an electric product (S801).

The operation state information includes an operation mode, an operation time period, and a run time that a user desires.

The operation S801 includes an operation of estimating the amount of power necessary to operate the electric product according to the operation state information and recognizing the estimated power consumption information.

The estimated power consumption information includes at least one of an estimated electricity charge and an estimated power consumption amount.

In addition, the operation state information includes information about an operation mode or an operation time period for operating the electric product according to a workload imposed on the electric product.

For example, if the electric product is a washing machine, the workload may be the weight and material of laundry, and if the electric product is a drying machine, the workload may be the weight of laundry to be dried. If the electric product is an air conditioner, the workload may be an indoor temperature change, and if the electric product is a refrigerator, the workload may include a temperature change in a refrigerator compartment.

Then, power information including an electricity rate varying with time is recognized (S802).

Next, an electricity charge is estimated which is necessary for operating the electric product in a desired operation mode for the current time period or a desired operation time period (S803).

In this state, it is determined whether a desired electricity charge is input as a reference electricity charge (S804). That is, it is determined whether the user expresses his/her intension actively by inputting a desired electricity charge as a limiting condition in operating the electric product.

If it is determined that a desired electricity charge is not input, the electric product is operated in the desired operation mode for the desired operation time period or the current time period (S809). On the other hand, if it is determined that a desired electricity charge is input, it is determined whether the electricity charge estimated for the current time period or the desired time period is greater than the desired electricity charge (S805).

Since the estimated electricity charge is for operating the electric product in the desired operation mode for the desired time period or the current time period, if the estimated electricity charge does not exceed the reference electricity charge input by the user, the electric product may be operated in the desired mode for the desired time period. That is, the electric product is operated in the desired operation mode (S809).

On the other hand, in operation S805, if it is determined that the estimated electricity charge exceeds the reference electricity charge (desired electricity charge), an operation time period during which the estimated electricity charge does not exceed the reference electricity charge is recommended (S806). The recommended operation time period during which the estimated electricity charge does not exceed the reference electricity charge may be later than the current time or different from the desired time period.

Next, it is determined whether the recommended time period is selected (S807). If the recommended time period is selected, the electric product is operated in the desired operation mode for the time period (S808).

In operation S807, the user may not select the recommended time period and change the desired electricity charge.

If the desired electricity charge is changed, it changes to a time period corresponding to the changed desired electricity charge, and the control device recognizes the change and displays the change on a display unit of the electric product or the EMS 30.

Thereafter, a time period during which an estimated electricity charge doest not exceed the changed desired electricity charge is re-recommended.

Next, it is determined whether the user selects the re-recommended time period (S807). If the re-recommended time period is selected, the electric product is operated in the desired operation mode for the re-recommended time period (S808).

In the current embodiment, if the estimated electricity charge exceeds the reference electricity charge (desired electricity charge), a time period during which the estimated electricity charge does not exceed the reference electricity charge is recommended, or a power-saving operation mode by which the estimated electricity charge does not exceed the reference electricity charge in the current time period or a desired operation time may be recommended. For example, in the case of a washing machine, if a desired operation mode is an intense course or a steam course, the power-saving operation mode may be a standard course.

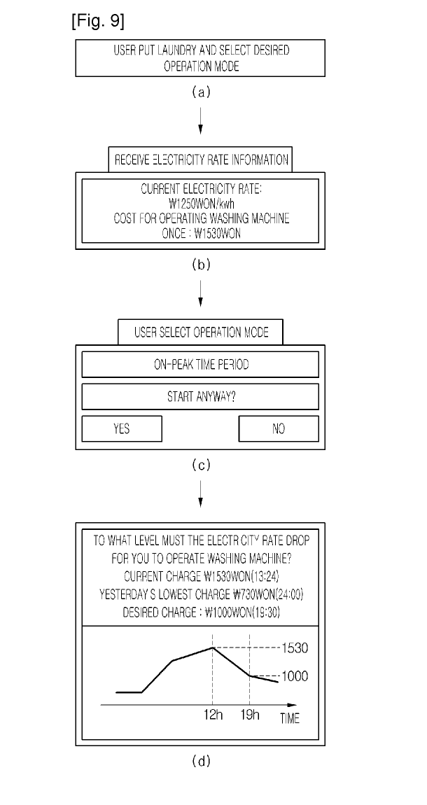

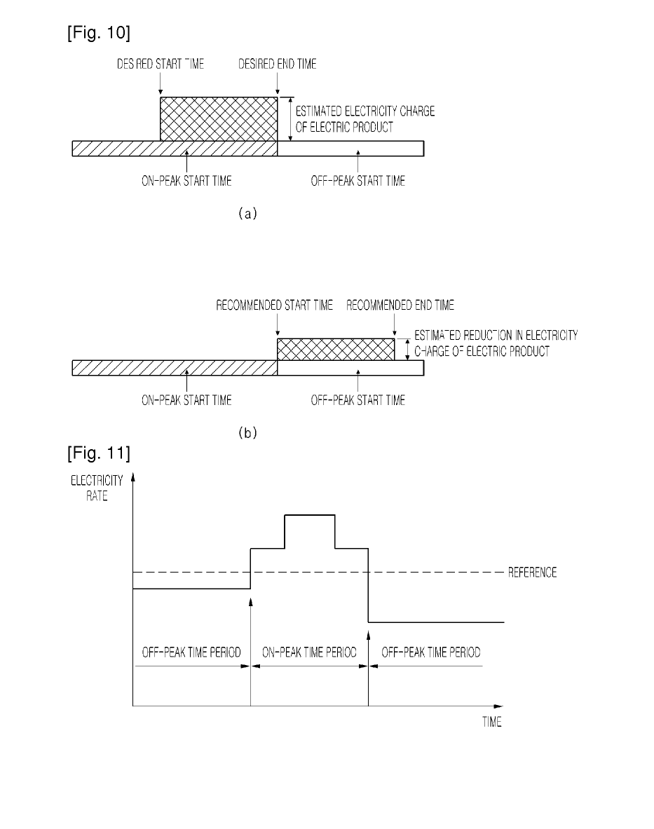

FIG. 9 is a view illustrating a screen of an electric product or an EMS on which different information is displayed according to the network system controlling method of FIG. 8; FIG. 10 is a graph illustrating a change of an operation time period of an electric product according to a desired electricity charge; and FIG. 11 is a graph illustrating an on-peak time period and an off-peak time period.

In FIG. 9, a washing machine is described as an example of an electric product. However, the concept of the present disclosure can be applied to other electric products such as a refrigerator, an air conditioner, and a cooking device.

Referring to FIG. 9, a user puts laundry into a washing machine and selects a desired operation mode. After the desired operation mode (or course) is selected, an estimated run time necessary for operating the washing machine in the desired operation mode may be displayed.

Then, power information such as electricity rate information is received and displayed, and an electricity charge necessary for operating the washing machine in the desired operation mode is calculated based on the power information (in FIG. 9, a washing cost for executing the washing machine once is calculated).

It is displayed whether the current time period or a desired time period is an on-peak time period the electricity rate of which is high or an off-peak time period the electricity rate of which is low. In the current embodiment, the on-peak time period and the off-peak time period may be determined based on a predetermined reference vale.

Then, buttons are displayed so that the user can select whether or not to operate the washing machine in the desired operation mode for the current time period or the desired time period.

As shown in FIG. 11, the on-peak time period means a relatively expensive time period the electricity rate of which is equal to or higher than a predetermined reference value, and the off-peak time period means a relative inexpensive time period the electricity rate of which is equal to or lower than the predetermined reference value.

If the user refuses to operate the washing machine in the desired operation mode for the current time period or the desired time period or the washing machine automatically refuses to operate in the desired operation mode for the current time period because the current time is included in the on-peak time period causing a high electricity charge, a desired electricity charge is received from the user.

Then, a time period resulting in an estimated electricity charge equal to or lower than the desired electricity charge is recommended.

For example, if the user sets his/her desired electricity charge to 1,000 won, it is displayed that the estimated electricity charge is equal to or lower than 1,000 won if the washing machine is operated at 19:30 or later, so as to inform the user of it.

If the user changes his/her desired electricity charge to 800 won, another time period corresponding to 800 won may be displayed.

As shown in FIG. 10, if an estimated electricity charge of an electric product is equal to or higher than a predetermined reference (a user's desired electricity charge) since the user desires an operation time period (a time period between desired start time and desired end time) involving an on-peak time period, a control device may recommend another operation time period (a time period between recommended start time and recommended end time) involving an off-peak time period so that the electric product can be operated in the recommended time period with an estimated electricity charge equal to or lower than the predetermined reference (the user's desired electricity charge).

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of controlling a network system, the method comprising:
recognizing power information and an operation mode of an electric product; and
providing an energy-saving operation mode to the electric product or operating the electric product in the energy-saving operation mode for reducing an energy-related value based on the recognized power information and the operation mode of the electric product.

2. The method according to claim 1, wherein the energy-related value comprises a power consumption amount or an electricity charge necessary for operating the electric product.

3. The method according to claim 1, wherein the energy-saving operation mode of the electric product for saving the energy-related value comprises an operation mode changed from the recognized operation mode or the recognized operation mode for a predetermined time period.

4. The method according to claim 3, wherein the predetermined time period comprises a time period different from a desired operation time period of the electric product or a time period after a current time.

5. The method according to claim 3, further comprising recognizing a desired power consumption amount or electricity charge for operating the electric product, wherein an estimated power consumption amount or electricity charge for operating the electric product in the recognized operation mode for the predetermined time period is equal to or lower than the desired power consumption amount or electricity charge.

6. The method according to claim 3, further comprising displaying the changed operation mode or the predetermined time period.

7. The method according to claim 1, further comprising displaying an estimated power consumption amount, an estimated electricity charge, or an estimated carbon dioxide emission amount in the case where the electric product is operated in the energy-saving operation mode for reducing the energy-related value.

8. The method according to claim 1, further comprising displaying an actual power consumption amount or electricity charge in the case where the electric product is operated in the energy-saving operation mode for reducing the energy-related value.

9. The method according to claim 1, further comprising displaying at least one of a reduced power consumption amount, a reduced electricity charge, or a reduced carbon dioxide emission amount in the case where the electric product is operated in the energy-saving operation mode for reducing the energy-related value.

10. The method according to claim 9, wherein the reduced power consumption amount, the reduced electricity charge, and the reduced carbon dioxide emission amount are amounts reduced when the electric product is operated in the energy-saving operation mode as compared with the case where the electric product is operated in the recognized operation mode.

11. The method according to claim 1, wherein after the electric product is operated in the energy-saving operation mode for reducing the energy-related value, energy-related information not displayed during the operation of the electric product is displayed.

12. The method according to claim 1, wherein the power information comprises at least one of information about supply power and information about an electricity charge.
